(19) United States
(12) Patent Application Publication
(10) Pub. No.: US 2010/0032855 A1
(43) Pub. Date: Feb. 11, 2010

(54) PLASTICIZING APPARATUS AND METHOD FOR CONTROLLING THE SAME

(75) Inventors: Kenichirou Inoue, Chiba (JP); Hiroaki Hayasaki, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd., Tokyo (JP)

(21) Appl. No.: 12/087,307

(22) PCT Filed: Dec. 27, 2006
(86) PCT No.: PCT/JP2006/326104

§ 371 Date: Apr. 29, 2009

(30) Foreign Application Priority Data
Jan. 12, 2006 (JP) 2006-5226

(51) Int. Cl. B29C 45/76; B29C 45/18

(52) U.S. Cl. 264/40.7; 425/557; 425/546

(57) ABSTRACT

An object is to improve the quality of molded articles and enable stable molding to be performed. A plasticizing apparatus includes a cylinder member having a molding material supply opening at a predetermined position, a molding material being supplied into the cylinder member via the molding material supply opening; and a metering member rotatably disposed within the cylinder member and adapted to plasticize the molding material when the metering member is rotated. A gas-flow-forming medium hole is formed in the cylinder member at a predetermined position. An open-close apparatus (37) is provided so as to open and close the gas-flow-forming medium hole. Since the open-close apparatus (37) is provided, a gas-flow-forming medium outside the cylinder member can be caused to enter the cylinder member.

### TECHNICAL FIELD

The present invention relates to a plasticizing apparatus and a method for controlling the same.

### BACKGROUND ART

Conventionally, in a molding machine; for example, in an injection-molding machine, resin (molding material) heated and melted in a heating cylinder is injected under high pressure and charged into a cavity of a mold apparatus, and the injected resin is cooled and solidified in the cavity, whereby a molded article is yielded.

For such a molding operation, the injection-molding machine includes a mold apparatus, a mold-clamping apparatus, and an injection apparatus serving as a plasticizing apparatus. The mold-clamping apparatus includes a stationary platen and a movable platen. The movable platen is advanced and retreated by a mold-clamping cylinder to thereby perform mold closing, mold clamping, and mold opening of the mold apparatus.

Meanwhile, the injection apparatus includes a heating cylinder for heating and melting resin fed from a hopper, and an injection nozzle for injecting the molten resin. A screw is disposed in the heating cylinder such that the screw can rotate, advance, and retreat. When the screw is advanced by a drive section connected to the rear end of the screw, resin is injected from the injection nozzle. When the screw is rotated by the drive section, resin is metered.

Incidentally, when an article is molded from a resin which generates a large amount of gas upon being heated, the molded article acquires a sink mark and/or resin burning occurs, so that the quality of the molded article lowers. In order to cope with such a problem, a passage for releasing gas; i.e., a gas vent is formed in a mold apparatus so as to release gas from the cavity via the gas vent.

In this case, troublesome maintenance work must be performed frequently so as to prevent the gas vent from being stopped up. In order to avoid such troublesome work, a connection jig is disposed between a heating cylinder and a hopper, and a hole is formed at a predetermined location of the heating cylinder. A flow of air is formed by means of establishing a negative pressure within the heating cylinder, to thereby discharge gas from the heating cylinder (see, for example, Patent Document 1).

Patent Document 1: Japanese Patent Application Laid-Open (kokai) No. 2001-121592.

### DISCLOSURE OF THE INVENTION

### Problems to be Solved by the Invention

However, in the above-described conventional injection apparatus, depending on the type of resin, temperature setting, etc., the resin may leak from the hole, or the leaked resin may solidify, making stable molding impossible.

An object of the present invention is to solve the above-mentioned problems in the conventional injection apparatus, and to provide a plasticizing apparatus and a method for controlling the same which can improve the quality of molded articles and enable stable molding to be performed.

### Means for Solving the Problems

In order to achieve the above object, a plasticizing apparatus of the present invention comprises a cylinder member having a molding material supply opening at a predetermined position, a molding material being supplied into the cylinder member via the molding material supply opening; and a metering member rotatably disposed within the cylinder member and adapted to plasticize the molding material when the metering member is rotated.

A gas-flow-forming medium hole is formed in the cylinder member at a predetermined position. Further, an open-close apparatus is provided so as to open and close the gas-flow-forming medium hole.

### EFFECTS OF THE INVENTION

According to the present invention, there is provided a plasticizing apparatus which comprises a cylinder member having a molding material supply opening at a predetermined position, a molding material being supplied into the cylinder member via the molding material supply opening; and a metering member rotatably disposed within the cylinder member and adapted to plasticize the molding material when the metering member is rotated.

A gas-flow-forming medium hole is formed at a predetermined position of the cylinder member. Further, an open-close apparatus is disposed so as to open and close the gas-flow-forming medium hole.

In this case, the open-close apparatus enables a gas-flow-forming medium outside the cylinder member to flow into the cylinder member. The gas-flow-forming medium having flowed into the cylinder member forms a gas flow toward the rear side within the cylinder member, and discharges gas to the outside of the cylinder member. Therefore, a sink mark, a void, or the like is not formed in a molded article, and burning of a molding material does not occur. Accordingly, defective molded articles are not produced. Further, since the gas does not flow into a mold apparatus, which gas would otherwise cause stopping up of an air vent of the mold apparatus, maintenance of the mold apparatus can be readily performed.

Further, when the open-close apparatus is closed, irrespective of the type of the molding material, temperature setting, or the like, it becomes possible to prevent leakage of the molding material from the gas-flow-forming medium hole, and solidification of the leaked molding material. Therefore, molding can be performed stably.

### BRIEF DESCRIPTION OF DRAWINGS

FIG. 1 is a sectional view of an injection apparatus according to an embodiment of the present invention.

FIG. 2 is a sectional view of an open-close apparatus according to the embodiment of the present invention.

### DESCRIPTION OF SYMBOLS

11: heating cylinder
12: screw
15: resin supply opening
18: hopper
32: seal ring
34: gas suction passage
36: medium supply hole
37: open-close apparatus

### BEST MODE FOR CARRYING OUT THE INVENTION

An embodiment of the present invention will next be described in detail with reference to the drawings. Notably, there will be described an injection molding machine, which is one type of a molding machine and which includes an injection apparatus serving as a plasticizing apparatus.

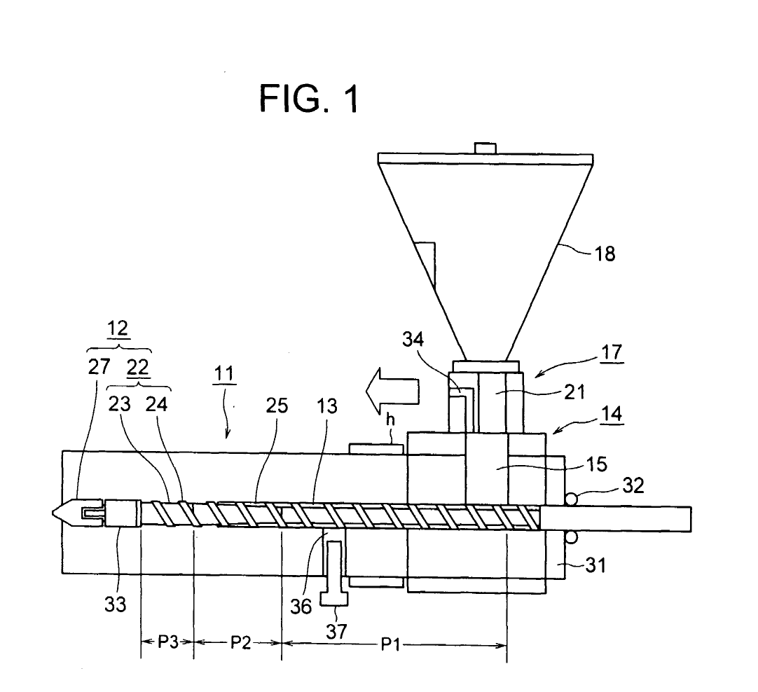

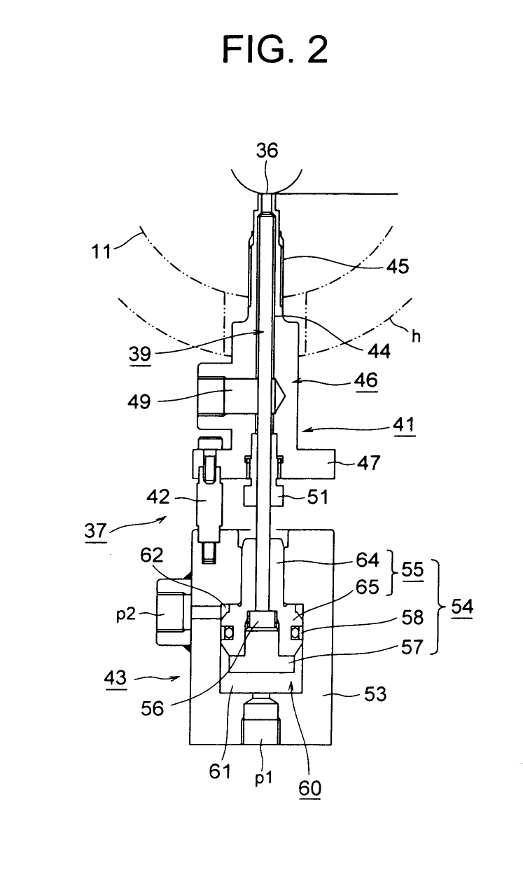

FIG. 1 is a sectional view of an injection apparatus according to the embodiment of the present invention; and FIG. 2 is a sectional view of an open-close apparatus according to the embodiment of the present invention.

In these drawing, reference numeral 11 denotes a heating cylinder, which serves as a cylinder member, and a through-hole 13 is formed in the heating cylinder 11 such that the through-hole 13 extends from the front end to the rear end. A screw 12, which serves as a metering member and an injection member, is rotatably disposed within the through-hole 13 such that the screw 12 can advance and retreat. An unillustrated injection nozzle is attached to the front end of the heating cylinder 11, and a nozzle opening is formed in the injection nozzle. Also, the heating cylinder 11 includes a water-cooling cylinder section (a cooling section) 14 formed at a predetermined position near the rear end. A resin supply opening (a molding-material supply opening) 15 is formed in the water-cooling cylinder section 14 to extend upward from the through-hole 13. Further, a hopper 18 for loading resin (a molding material) is attached to the top of the water-cooling cylinder section 14 via a connection jig (a loading section) 17. The connection jig 17 has a communication opening 21 which establishes communication between the resin supply opening 15 and the interior of the hopper 18. An unillustrated medium channel is formed in the water-cooling cylinder section 14. A cooling medium (e.g., water) supplied from an unillustrated cooling-medium supply source is caused to flow into the medium channel via a medium supply opening. After having cooled the water-cooling cylinder section 14, the cooling medium is discharged from an unillustrated medium discharge opening, and is returned to the cooling-medium supply source. Notably, the heating cylinder 11, the screw 12, the resin supply opening 15, and the hopper 18 constitute an injection apparatus.

Further, flat heaters h (FIG. 1 shows only one heater at the rear end) are disposed on the outer circumference of the heating cylinder 11. The resin within the heating cylinder 11 can be heated and melted through supply of electricity to the heaters h.

The screw 12 includes a flight section 22, and a screw head 27 connected to the front end of the flight section 22. The flight section 22 includes a flight 24 spirally formed on the outer circumferential surface of a screw main body 23, and a spiral groove 25 is formed along the fight 24. Further, the flight section 22 includes a supply portion P1, a compression portion P2, and a metering portion P3, which are successively formed from the rear toward the front. The supply portion P1 receives resin supplied via the resin supply opening 15. The compression portion P2 melts the supplied resin, while compressing the same. The metering portion P3 meters the molten resin, supplying a fixed amount at a time. The outer diameter of the screw main body 23, as measured at the bottom of the groove 25, is determined such that the outer diameter is relatively small at the supply portion P1, gradually increases in the compression portion P2 from the rear end to the front end thereof, and is relatively large at the metering portion P3. Accordingly, the clearance between the inner circumferential surface of the through-hole 13 and the outer circumferential surface of the screw main body 23 is relatively large at the supply portion P1, gradually decreases in the compression portion P2 from the rear end to the front end thereof, and is relatively small at the metering portion P3.

Further, the rear end of the water-cooling cylinder section 14 is connected to an unillustrated drive section case via a connection block 31. An unillustrated injection motor (a drive section for injection), an unillustrated metering motor (a drive section for metering), etc. are disposed within the drive section case, and are connected to the screw 12. A seal ring (a seal member) 32 for sealing the through-hole 13 is provided on the connection block 31.

In the present embodiment, electric servomotors are used as the injection motor and the metering motor. Notably, an injection cylinder may be used in place of the injection motor, and a hydraulic motor may be used in place of the metering motor.

When the screw 12 is rotated in a regular direction through drive of the metering motor in a metering step, the resin within the hopper 18 is supplied to the supply portion P1 via the communication opening 21 and the resin supply opening 15, and is caused to advance along the groove 25. As a result, the screw 12 is retreated, and the resin is accumulated forward of the screw head 27 within the through-hole 13. Notably, the resin within the groove 25 assumes the form of pellets in the supply portion P1, is brought into a half-melted state in the compression portion P2, and is melted completely to a liquid state in the metering portion P3.

When the screw 12 is advanced through drive of the injection motor in an injection step, the resin accumulated forward of the screw head 27 is injected from the injection nozzle and is charged into a cavity of an unillustrated mold apparatus. In order to prevent reverse flow of the resin accumulated forward of the screw head 27, a reverse-flow prevention apparatus 33 is disposed at the screw head 27.

Incidentally, when resin is heated and melted, a gas is generated. If the resin containing the generated gas is molded as is, a sink mark is formed on a molded article, and/or burning of the molding material; i.e., resin burning, occurs, so the quality of the molded article deteriorates. In order to solve this problem, a gas suction passage 34 is formed in the connection jig 17 such that the gas suction passage 34 communicates with the resin supply opening 15. The gas suction passage 34 is connected to an unillustrated negative-pressure generating apparatus, which serves as a suction means. For example, a vacuum apparatus may be used as the negative-pressure generating apparatus. When the negative-pressure generating apparatus is activated, a gas generated in the heating cylinder 11 is sucked in the direction of an arrow shown in FIG. 1 via the gas suction passage 34 and the resin supply opening 15, whereby a negative pressure is generated within the heating cylinder 11.

Further, the heating cylinder 11 has a medium supply hole (a gas-flow-forming medium hole) 36 for forming a gas flow; i.e., a flow of gas within the heating cylinder 11. The medium supply hole 36 is formed, in the form of a through hole, at a predetermined position of the heating cylinder 11. In the present embodiment, the medium supply hole 36 is formed at a position near the front end of the supply portion P1, as measured when the screw 12 is placed at the illustrated advancement limit position, such that the medium supply hole 36 is located at the lowest end in the circumferential direction of the heating cylinder 11. An open-close apparatus 37 for opening and closing the medium supply hole 36 is fitted into the medium supply hole 36.

The open-close apparatus 37 includes a guide section 41 and an open-close cylinder section 43, which serves as an open-close drive section. The guide section 41 is attached to the heating cylinder 11, assumes a tubular shape, and guides a valve pin (open-close member) 39 for opening and closing the medium supply hole 36. The open-close cylinder section 43 is attached to the guide section 41 via a plurality of (four, in the present embodiment) connection bars (connection members) 42 (FIG. 2 shows only one connection bar), and advances and retreats the valve pin 39.

The guide section 41 includes an attachment portion 45 of small diameter, which is formed to be located in the heating cylinder 11 and is used to attach the open-close apparatus 37 to the heating cylinder 11; a main body portion 46 of large diameter which is located adjacent to the attachment portion 45 and is formed to project from the heating cylinder 11; and a flange portion 47 for connecting the guide portion 41 and the open-close cylinder section 43. At the guide portion 41, a guide hole 44 is formed to pass through the guide portion 41. The guide hole 44 accommodates and guides the valve pin 39.

An unillustrated external thread is formed on the outer circumferential surface of the attachment portion 45, and an unillustrated internal thread is formed on the inner circumferential surface of the medium supply hole 36. The open-close apparatus 37 can be attached to the heating cylinder 11 by means of rotating the guide portion 41 and engaging the external thread and the internal thread with each other. Further, the main body portion 46 has an air supply/discharge opening (a medium passage) 49 formed to extend in a direction perpendicular to the guide hole 44. The air supply/discharge opening 49 is used to introduce air (a gas-flow-forming medium) into the heating cylinder 11 and discharge the air from the heating cylinder 11. An alignment member 51 is disposed at the lower end of the guide portion 41 so as to align the valve pin 39. The alignment member 51 supports the valve pin 39 in a slidable manner. Notably, an annular clearance is formed between the inner circumferential surface of the guide hole 44 and the outer circumferential surface of the valve pin 39, and communicates with the air supply/discharge opening 49.

The open-close cylinder section 43 includes a cylinder main body 53 having a cylinder chamber 60, and a piston 54 slidably disposed within the cylinder chamber 60. By means of the piston 54, air chambers (first and second chambers) 61 and 62 are formed within the cylinder main body 53. The piston 54 includes a first holding member 55, a second holding member 57 located behind the first holding member 55, and an O-ring (a seal member) 58 disposed on the outer circumferential surface of the first holding member 55. The second holding portion 57 holds the valve pin 39 in cooperation with the first holding member 55, by pushing from the rear side a coming-off preventing portion 56 formed at the rear end of the valve pin 39.

The first holding member 55 includes a first tubular portion 64, and a second tubular portion 65 which is located rearward of and adjacent to the first tubular portion 64 and whose outer diameter is larger than that of the first tubular portion 64. The first tubular portion 64 is disposed forward of the cylinder chamber 60 to be slidable in relation to the cylinder main body 53, and surrounds the valve pin 39 over a predetermined length. The second tubular portion 65 is disposed within the cylinder chamber 60 to be slidable in relation to the cylinder main body 53. A stepped portion is formed between the inner circumferential surface of the second tubular portion 65 and that of the first tubular portion 64, and the coming-off preventing portion 56 is engaged with the stepped portion.

The air chambers 61 and 62 are connected to an unillustrated pneumatic circuit via ports p1 and p2. The pneumatic circuit includes air compressing means, a changeover valve, etc. An unillustrated control section drives the solenoid of the changeover valve.

In the present embodiment, the first tubular portion 64 extends axially over a predetermined length, and is caused to slide in relation to the cylinder main body 53. Therefore, the valve pin 39 can be held accurately.

Further, in the present embodiment, the guide portion and the open-close cylinder section 43 are separated from each other, and are connected together via the connection bars 42. Therefore, even when heat of the heating cylinder is transferred to the guide portion 41 attached to the heating cylinder 11, transmission of heat to the open-close cylinder section 43 is suppressed. Accordingly, when a pneumatic cylinder is used as the open-close cylinder section 43, thermal expansion of air can be prevented. As a result, the open-close cylinder section 43 can be driven accurately.

In the injection apparatus having the above-described structure, open processing means (an open processing section) of the control section performs open processing so as to open the medium supply hole 36 during at least a predetermined period in a metering step (in the present embodiment, between the start of the metering step and the end thereof). Specifically, through operation of the changeover valve, the open processing means supplies air to the second air chamber 62 via the port p2 and discharges air from the first air chamber 61 via the port p1 so as to retreat the piston 54, to thereby retreat the valve pin 39, whereby the medium supply hole 36 is opened. Notably, in the present embodiment, since the metering step is started when a predetermined first delay time (e.g., 0.2 to 0.3 sec) has elapsed after the changeover valve had been operated, the medium supply hole 36 can be reliably opened at a point in time when the metering step is started. Accordingly, consistent degassing can be performed at the point in time when the metering step is started.

Further, negative-pressure generation processing means (a negative-pressure generation processing section) of the control section performs negative-pressure generation processing so as to drive the negative-pressure generation apparatus during at least a period in which the medium supply hole 36 is opened (in the present embodiment, between the start of the metering step and the end thereof), so as to generate a negative pressure (vacuum) within the heating cylinder 11, to thereby suck gas from the heating cylinder 11.

As a negative pressure is generated within the heating cylinder 11, air outside the heating cylinder 11 enters the heating cylinder 11 via the air supply/discharge opening 49 and the medium supply hole 36. The air having entered the heating cylinder 11 (FIG. 1) is caused to flow rearward within the heating cylinder 11, whereby a rearward gas flow is formed along the screw 12, whereby the gas is pushed out toward the gas suction passage 34, and is discharged to the outside of the heating cylinder 11 in the direction of the arrow.

Further, since the gas within the heating cylinder 11 can be sucked and removed to a sufficient degree, a molded article does not have a sink mark, a void, or the like, and resin burning does not occur. Accordingly, defective molded articles are not produced. Further, since the gas does not flow into a mold apparatus, whereby gas would otherwise cause stopping up of an air vent of the mold apparatus, maintenance of the mold apparatus can be readily performed.

During this period, air does not enter the heating cylinder 11 from the rear end thereof, because the rear end of the heating cylinder 11 is sealed by means of the seal ring 32. Accordingly, a negative pressure of a sufficient level can be generated within the heating cylinder 11, and thus, the force with which gas is sucked can be increased.

Since the medium supply hole 36 is formed at a position near the front end of the supply portion P1, as measured when the screw 12 is placed at the advancement limit position, a gas generated when the resin is heated and starts to melt at the compression portion P2 can be sucked efficiently.

Since the resin is not melted in the supply portion P1, the air having entered the heating cylinder 11 via the medium supply hole 36 does not react with the resin.

Subsequently, when the metering step ends and an injection step is started, close processing means (a close processing section) of the control section performs close processing so as to close the medium supply hole 36 during at least the period of the injection step (in the present embodiment, between the start of the injection step and the end thereof). Specifically, through operation of the changeover valve, the close processing means supplies air to the first air chamber 61 via the port p1 and discharges air from the second air chamber 62 via the port p2 so as to advance the piston 54, to thereby advance the valve pin 39, whereby the medium supply hole 36 is closed. Notably, in the present embodiment, since the injection step is started when a predetermined second delay time (e.g., 0.2 to 0.3 sec) has elapsed after the changeover valve had been operated, the medium supply hole 36 can be reliably closed at a point in time when the injection step is started.

Further, during the period in which the injection step is performed, the negative-pressure generation processing means continuously drives the negative-pressure generation apparatus so as to continuously generate a negative pressure within the heating cylinder 11, to thereby continue suction of gas from the heating cylinder 11.

As described above, in the present embodiment, the medium supply hole 36 is closed during the period between the start and end of the injection step. Therefore, irrespective of the type of the molding material, temperature setting, or the like, it becomes possible to prevent leakage of the resin from the medium supply hole 36, and solidification of the leaked resin. Therefore, molding can be performed stably.

In the present embodiment, air is used as the gas-flow-forming medium. However, an inert gas such as nitrogen gas may be used. Further, when the medium supply hole 36 is opened, communication between the interior and the exterior of the heating cylinder 11 is established, and air of atmospheric pressure flows into the heating cylinder 11 via the medium supply hole 36. However, compressed air, inert gas, or the like may be supplied as the gas-flow-forming medium. In this case, an unillustrated pump (compressing means) for compressing the air, inert gas, or the like is connected to the air supply/discharge opening 49 and the medium supply hole 36.

The present invention is not limited to the above-described embodiment. Numerous modifications and variations of the present invention are possible in light of the spirit of the present invention, and they are not excluded from the scope of the present invention.

### INDUSTRIAL APPLICABILITY

The present invention is applicable to an injection apparatus of an injection molding machine.

1. A plasticizing apparatus, comprising:
(a) a cylinder member which comprises a molding material supply opening at a predetermined position, a molding material being supplied into the cylinder member via the molding material supply opening; and
(b) a metering member rotatably disposed within the cylinder member and adapted to plasticize the molding material when the metering member is rotated, wherein
(c) a gas-flow-forming medium hole is formed in the cylinder member at a predetermined position, and
(d) an open-close apparatus is provided so as to open and close the gas-flow-forming medium hole.

2. A plasticizing apparatus according to claim 1, further comprising open processing portion which opens the open-close apparatus during at least a predetermined period in a metering step.

3. A plasticizing apparatus according to claim 1, further comprising close processing portion which closes the open-close apparatus during at least an injection step.

4. A plasticizing apparatus according to claim 1, further comprising a seal member which is disposed at a rear end of the cylinder member and seals the interior of the cylinder member.

5. A plasticizing apparatus according to claim 1, wherein a negative-pressure generation apparatus is connected to the gas-flow-forming medium hole.

6. A plasticizing apparatus according to claim 1, further comprising negative-pressure generation processing portion which generates a negative pressure within the cylinder member by a negative-pressure generation apparatus during at least a period during which the open-close apparatus is opened.

7. A method for controlling a plasticizing apparatus comprising a cylinder member comprising a molding material supply opening at a predetermined position, a molding material being supplied into the cylinder member via the molding material supply opening, and a metering member rotatably disposed within the cylinder member and adapted to plasticize the molding material when the metering member is rotated, wherein a gas-flow-forming medium hole is formed in the cylinder member at a predetermined position, and an open-close apparatus is provided so as to open and close the gas-flow-forming medium hole, the method comprising:
closing the open-close apparatus during at least an injection step.
